(19) United States
(12) Patent Application Publication
(10) Pub. No.: US 2019/0379596 A1
(43) Pub. Date: Dec. 12, 2019

(54) Methods and Systems preventing Make Before Break failures during soft preemption in MPLS

(71) Applicant: Ciena Corporation, Hanover, MD (US)

(72) Inventors: Piyush Sharma, Gurgaon (IN); Sudarshan Sodhani, Gurgaon (IN)

(21) Appl. No.: 16/042,236

(22) Filed: Jul. 23, 2018

(30) Foreign Application Priority Data
Jun. 8, 2018 (IN) 201811021497

(51) Int. Cl. H04L 12/707; H04L 12/723; H04L 12/703

(52) U.S. Cl. CPC H04L 45/22; H04L 67/28; H04L 45/28; H04L 45/50

(57) ABSTRACT

A method implemented at an intermediate node in a Multiprotocol Label Switching (MPLS) network to prevent Make Before Break (MBB) failures during soft preemption of a lower priority Label Switched Path (LSP) includes, responsive to a determination the lower priority LSP needs preemption, determining a first route of a higher priority LSP which caused the preemption and bandwidth on the first route; determining a second route which is a current route of the lower priority LSP and bandwidth on the second route; analyzing the first route and the second route to determine one or more excluded interfaces which do not support the lower priority LSP due to the higher priority LSP; and transmitting a preemption message designating a soft preemption of the lower priority LSP including all of the excluded interfaces therein towards an ingress node along the second route.

### FIELD OF THE DISCLOSURE

The present disclosure generally relates to networking systems and methods. More particularly, the present disclosure relates to systems and methods for prevention of Make Before Break (MBB) failures during soft preemption in Multiprotocol Label Switching (MPLS) and the like.

### BACKGROUND OF THE DISCLOSURE

Multiprotocol Label Switching (MPLS) is a scalable, protocol-independent transport technique where data (packets, wavelengths, frames, etc.) is assigned labels which are used for forwarding decisions. Label Switched Paths (LSPs) are set up in MPLS utilizing a signaling protocol to establish specific paths through an MPLS network. LSPs can be soft preempted, such as described in RFC 5712 “MPLS Traffic Engineering Soft Preemption” (January 2010), the contents of which are incorporated by reference. Soft preemption attempts to establish a new path for a preempted LSP before tearing down the original LSP, so-called Make Before Break (MBB). MBB means, when preempting an LSP, the new route is made (Make) before the LSP is torn down (Break) and moved. That is, the MBB operation enables a switch of the preempted LSP from the current route to the new route avoiding a gap in data transmission referred to as a traffic hit (other than switch time). The default behavior without soft preemption is to tear down a preempted LSP first, signal a new path, and then reestablish the LSP over the new path. In the interval between when the path is taken down and the new LSP is established, any traffic attempting to use the LSP is lost. Soft preemption prevents this type of traffic loss. The trade-off is that during the time when an LSP is soft preempted, two LSPs with their corresponding bandwidth requirements are used until the original path is torn down. MPLS soft preemption is advantageous due to the minimal traffic impact to the preempted LSP.

### BRIEF SUMMARY OF THE DISCLOSURE

Disadvantageously, the conventional soft preemption technique often leads to MBB failures. Specifically, the conventional soft preemption technique only notifies a node that the LSP needs to be preempted at a single interface. In route computations for moving the preempted LSP, only this single interface is excluded. However, there may be additional interfaces which should be excluded due to bandwidth issues (such as related to the preemption). These additional interfaces may be included in the new route, causing multiple path failures trying to reroute the preempted LSP.

In an embodiment, a method is implemented at an intermediate node in a Multiprotocol Label Switching (MPLS) network to prevent Make Before Break (MBB) failures during soft preemption of a lower priority Label Switched Path (LSP). The method includes, responsive to a determination the lower priority LSP needs preemption, determining a first route of a higher priority LSP which caused the preemption and bandwidth on the first route; determining a second route which is a current route of the lower priority LSP and bandwidth on the second route; analyzing the first route and the second route to determine one or more excluded interfaces which do not support the lower priority LSP due to the higher priority LSP; and transmitting a preemption message designating a soft preemption of the lower priority LSP including all of the excluded interfaces therein towards an ingress node along the second route. The preemption message can include a PATH ERROR message and the excluded interfaces are listed in an EXCLUDE_ROUTE object.

The method can further include receiving a second preemption message for a second lower priority LSP and a second higher priority LSP; determining any local interfaces listed in the excluded interfaces of the second preemption message; and preventing transmission of any preemption messages for the second lower priority LSP based on the local interfaces which are listed in the excluded interfaces of the second preemption message. The method can further include receiving a second preemption message for a second lower priority LSP and a second higher priority LSP, wherein the intermediate node is an ingress node for the second lower priority LSP; determining any excluded interfaces listed in the excluded interfaces of the second preemption message; and determining and signaling a new path for the second lower priority LSP exclusive of the excluded interfaces.

The excluded interfaces can include an address of a local interface at the intermediate node and one or more addresses of remote interfaces of nodes that are in the first route of the higher priority LSP. The preemption message can be transmitted to upstream towards an ingress node for the lower priority LSP and through one or more additional intermediate nodes. The one or more additional intermediate nodes can analyze the preemption message for any of its local interfaces contained in the excluded interfaces and prevents sending another preemption for the lower priority LSP for any local interface in the excluded interfaces. The ingress node can determine and signal a new path for the lower priority LSP exclusive of the excluded interfaces upon receipt of the preemption message.

In another embodiment, a node in a Multiprotocol Label Switching (MPLS) network is configured to prevent Make Before Break (MBB) failures during soft preemption of a lower priority Label Switched Path (LSP). The node includes a plurality of ports; forwarding circuitry configured to forward data between the plurality of ports; and control circuitry communicatively coupled to the plurality of ports and the forwarding circuitry and configured to, responsive to a determination the lower priority LSP needs preemption, determine a first route of a higher priority LSP which caused the preemption and bandwidth on the first route, determine a second route which is a current route of the lower priority LSP and bandwidth on the second route, analyze the first route and the second route to determine one or more excluded interfaces which do not support the lower priority LSP due to the higher priority LSP, and cause transmission of a preemption message designating a soft preemption of the lower priority LSP including all of the excluded interfaces therein towards an ingress node along the second route of the lower priority LSP.

The preemption message can include a PATH ERROR message and the excluded interfaces are listed in an EXCLUDE_ROUTE object. The control circuitry can be further configured to, responsive to reception of a second preemption message for a second lower priority LSP and a second higher priority LSP, determine any local interfaces listed in the excluded interfaces of the second preemption message, and prevent transmission of any preemption messages for the second lower priority LSP based on the local interfaces which are included in the excluded interfaces of the second preemption message.

The control circuitry can be further configured to, responsive to reception of a second preemption message for a second lower priority LSP and a second higher priority LSP, wherein the node is an ingress node for the second lower priority LSP, determine any excluded interfaces listed in the excluded interfaces of the second preemption message, and determine and cause signaling of a new path for the second lower priority LSP exclusive of the excluded interfaces. The excluded interfaces can include an address of a local interface at the node and one or more addresses of remote interfaces of nodes that are in a route of the higher priority LSP.

The preemption message can be transmitted to upstream an ingress node for the lower priority LSP and through one or more additional intermediate nodes. The one or more additional intermediate nodes can analyze the preemption message for any local interface contained in the excluded interfaces and prevent sending another preemption for the lower priority LSP for the local interface in the excluded interfaces. The ingress node can determine and signal a new path for the lower priority LSP exclusive of the excluded interfaces upon receipt of the preemption message.

In a further embodiment, a Multiprotocol Label Switching (MPLS) network is configured to prevent Make Before Break (MBB) failures during soft preemption of a lower priority Label Switched Path (LSP). The MPLS network includes a plurality of nodes interconnected by a plurality of links; wherein a lower priority LSP is configured over the plurality of links, and, responsive to a reservation for a higher priority LSP, an intermediate node of the plurality of nodes is configured to determine a requirement to preempt the lower priority LSP due to the higher priority LSP, determine a first route of the higher priority LSP and bandwidth on the first route, determine a second route which is a current route of the lower priority LSP and bandwidth on the second route, analyze the first route and the second route to determine one or more excluded interfaces which do not support the lower priority LSP due to the higher priority LSP, and transmit a preemption message designating a soft preemption of the lower priority LSP including all of the excluded interfaces therein towards an ingress node along the second route.

The preemption message can include a PATH ERROR message and the excluded interfaces can be listed in an EXCLUDE_ROUTE object. Another intermediate node can be configured to, responsive to reception of the preemption message, determine any local interfaces listed in the excluded interfaces of the preemption message, and prevent transmission of any preemption messages for the lower priority LSP based on the local interfaces which are included in the excluded interfaces of the second preemption message. An ingress node of the lower priority LSP can be configured to, responsive to reception of the preemption message, determine any excluded interfaces listed in the excluded interfaces of the preemption message, and determine and cause signaling of a new path for the lower priority LSP exclusive of the excluded interfaces.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of an MPLS network with multiple nodes interconnected by multiple links;

FIGS. 2 and 3 are network diagrams of the MPLS network of FIG. 1 describing conventional soft preemption of a Low Priority (LP) Label Switched Path (LSP) based on a High Priority (HP) LSP;

FIG. 4 is a flowchart of a process implemented at an intermediate node, such as the LSR nodes in FIGS. 2 and 3, responsive to a need to preempt a lower priority LSP, to prevent Make Before Break (MBB) failures in MPLS soft preemption;

FIG. 5 is a flowchart of a process implemented at an intermediate node, such as the LSR nodes in FIGS. 2 and 3, responsive to receiving a preemption message, to reduce the number of preemption messages in MPLS soft preemption;

FIG. 6 is a flowchart of a process implemented at a Label Edge Router (LER), responsive to receiving a preemption message, to reroute the lower priority LSP avoiding MBB failures;

FIGS. 7 and 8 are network diagrams of the MPLS network of FIG. 1 describing soft preemption of the Low Priority (LP) Label Switched Path (LSP) based on the High Priority (HP) LSP, utilizing the processes of FIGS. 4, 5, and 6; and

FIG. 9 is a block diagram of an example implementation of a node which may be used with the systems and methods.

### DETAILED DESCRIPTION OF THE DISCLOSURE

In various embodiments, the present disclosure relates to systems and methods for prevention of Make Before Break (MBB) failures during soft preemption in Multiprotocol Label Switching (MPLS) and the like. Specifically, the systems and methods augment a PATH ERROR message with multiple interface addresses (e.g., Internet Protocol (IP) address) which should be excluded by a head-end node (LER) in a route computation for a new route for a preempted LSP. In this manner, MBB failures are reduced in MPLS soft preemption. Conventionally, the PATH ERROR message only includes a local interface address that generated the PATH ERROR message. Further, individual nodes (Label Switched Routers (LSRs) each send their own PATH ERROR message. The systems and methods include an EXCLUDE_ROUTE object in the PATH ERROR message with multiple interface addresses to avoid. As this PATH ERROR message traverses from the initiating node (LSR) to a LER (head end), intermediate nodes can use the EXCLUDE_ROUTE object to check if a local interface address that should in fact be included in the EXCLUDE_ROUTE object and restrain themselves from sending multiple PATH ERROR messages for the same preempted LSP. Advantageously, the LER can receive a single PATH ERROR message with the single EXCLUDE_ROUTE object, enabling a new route calculation which can exclude all of the interface addresses thereby reducing MBB failures.

The systems and methods prevent MBB failure scenarios for preempted LSPs during soft preemption by high priority LSPs, preventing traffic loss of preempted LSP. Of note, soft preemption is a likely and common occurence in MPLS-Traffic Engineering (TE) networks as all LSPs try to establish on the best route and the expectation is this operation to be hitless (e.g., confined to a single switch between routes) and MBB failure could lead to larger traffic loss. Also, while described herein with reference to MPLS and MPLS-TE, the systems and methods contemplate operation with Generalized MPLS and other data transport techniques which use soft preemption.

### MPLS Network

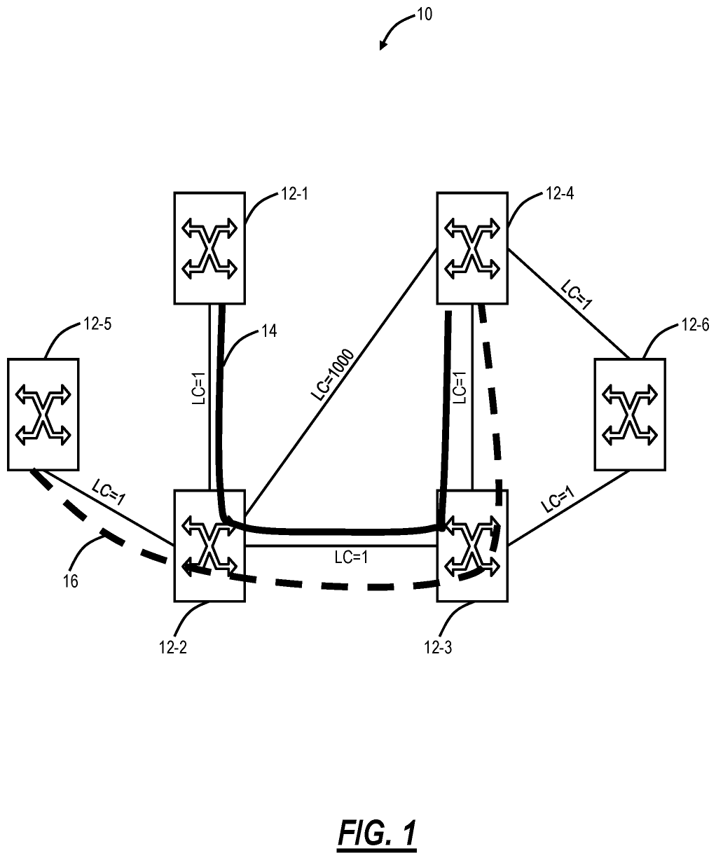

FIG. 1 is a network diagram of an MPLS network 10 with multiple nodes 12 (labeled as nodes 12-1-12-6) interconnected by multiple links. Each link includes a Link Cost (LC). In this example, all links have an LC of 1 except the link between the nodes 12-2, 12-4 which is set arbitrarily high (1000). Also, in this example, the MPLS network 10 includes a Low Priority (LP) LSP 14 between the nodes 12-1, 12-2, 12-3, 12-4 which is operating and there is a desire to create a High Priority (HP) LSP 16 between the nodes 12-5, 12-2, 12-3, 12-4 which requires preemption of the LP LSP 14. The nodes 12 can be referred to as Label Switched Router (LSRs) or Label Edge Routers (LERs) based on their position in each LSP 14, 16. Within the MPLS network 10, an LSR is configured to forward traffic along the LSPs between the LERs. For example, for the LSP 14, the nodes 12-1, 12-4 are the LERs and the nodes 12-2, 12-3 are the LSRs. For the LSP 16, the nodes 12-5, 12-4 are the LERs and the nodes 12-2, 12-3 are the LSRs. Those skilled in the art recognize the MPLS network 10, the nodes 12, and the LSPs 14, 16 are presented for illustration purposes and other network configurations are possible.

In MPLS-Traffic Engineering (TE), the LSPs 14, 16 are established with TE parameters such as LC, setup priority, hold priority, preemption capability (hard or soft), bandwidth, etc. Constrained Shortest Path First (CSFP) utilizes these TE parameters to calculate the best path for LSP establishment. In this example, there is insufficient bandwidth to support the HP LSP 16 between the nodes 12-2, 12-3, requiring soft preemption of the LP LSP 14.

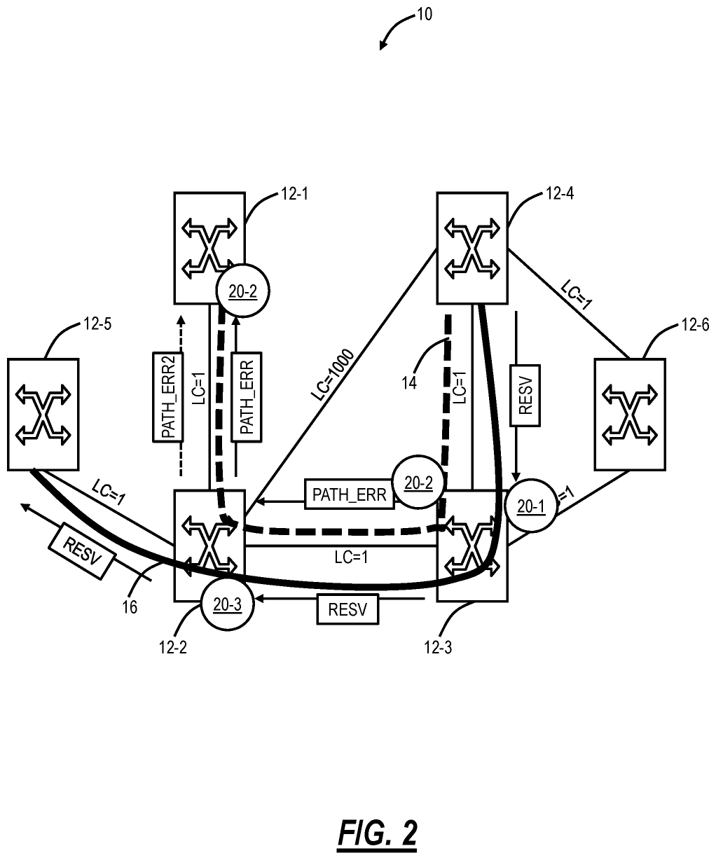

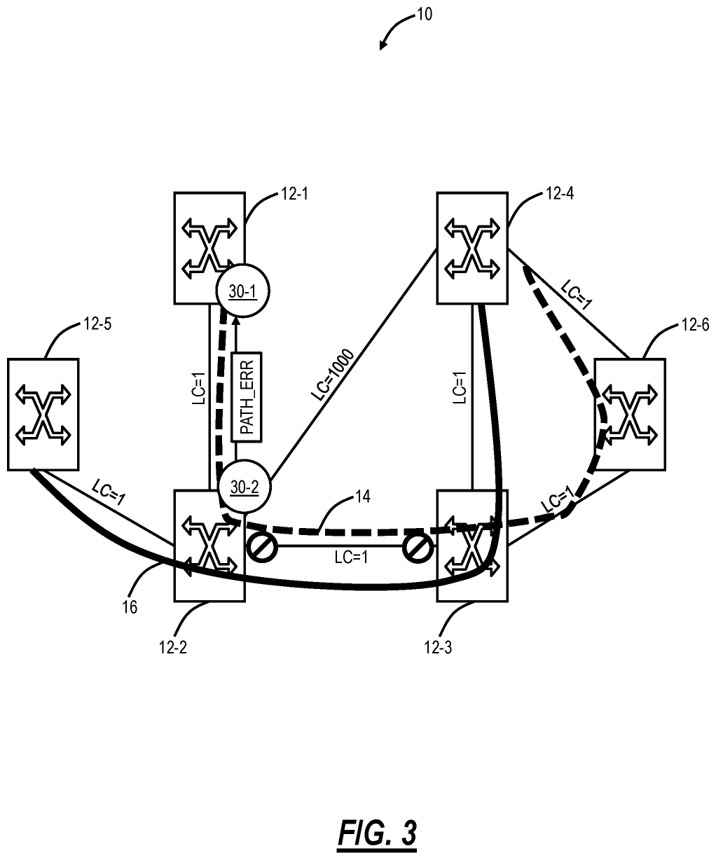

FIGS. 2 and 3 are network diagrams of the MPLS network 10 describing conventional soft preemption of the Low Priority (LP) Label Switched Path (LSP) 14 based on the High Priority (HP) LSP 16. Resource Reservation Protocol (RSVP) TE can be used to establish the LSPs 14, 16, taking into consideration network constraint parameters such as available bandwidth and explicit hops. For example, RSVP-TE is detailed in RFC 3209 (updated by RFC 5151), the contents of each are incorporated by reference. At a step 20-1, the LER node 12-4 sends a RESV message to the LSR node 12-3 destined for the LER node 12-5 for the HP LSP 16. The RESV message contains details of the TE parameters of the HP LSP 16 including its priority which is higher than the LP LSP 14 and bandwidth requirements.

When the LSR node 12-3 receives the RESV message for the HP LSP 16, the LSR node 12-3 determines the LP LSP 14 needs to be preempted. Soft preemption is used in a Make Before Break (MBB) fashion to preempt the LP LSP 14 in order to admit HP LSP 16 (e.g., bandwidth is not available on an interface to admit the HP LSP 16). At a step 20-2, the ingress LER node 12-1 of the LP LSP 14 (i.e., the preempted LSP) is informed with a PATH ERROR (PathErr) message from the LSR node 12-3 with an error code indicating reroute using soft preemption. The problematic interface is also specified in the PATH ERROR message. On receiving the PATH ERROR message at the LER node 12-1, the LER node 12-1 will block the interface address in the PATH ERROR message and generate a new PATH message over all links towards the LER node 12-4.

At a step 20-3 (which may be concurrent, before, or after the step 20-2), the LSR node 12-2 receives the RESV message for the HP LSP 16 and also determines the LP LSP 14 must be preempted. The LSR node 12-2 sends a second PATH ERROR message to the LER node 12-1. In this example, the PATH ERROR message from the LSR node 12-2 is not processed by the LER node 12-1 as an MBB operation is already in progress based on the PATH ERROR message from the LSR node 12-3.

Of note, the preemption is on specific interfaces on the LSR nodes 12-2, 12-3. In this example, the link between the LSR nodes 12-2, 12-3 has insufficient bandwidth to support the HP LSP 16 along with the LP LSP 14. Thus, the LP LSP 14 must be preempted at the two interfaces at the end of this link.

The PATH ERROR message is described in RFCs 5712 (January 2010) and 5710 (January 2010), each of which is incorporated by reference. RFC 5710 describes a new reroute-specific error code that allows a midpoint (LSR) to report a TE LSP reroute request (Error Code=34−Reroute). RFC 5712 specifies a new Error value sub-code for soft preemption. The PATH ERROR message contains an ERROR_SPEC object of the format defined in RFC 2205 (September 1997) or RFC 3473 (January 2003), each of which is incorporated by reference.

The ERROR_SPEC object includes the interface address (e.g., IP address) of the interface that detected the error, i.e., the error is the interface which does not have the bandwidth to admit both LSPs 14, 16. The ingress LER node 12-1 then computes a new path using CSPF and establishes a new tunnel using MBB with the exclusion of the interface address received in the PATH ERROR message. Note, Interior Gateway Protocol (IGP) updates are slower and the TE database is not updated yet to know that other interfaces should be excluded.

In FIG. 3, the LER node 12-1 sends the new PATH message between the nodes 12-1, 12-2, 12-3, 12-6, 12-4, at a step 30-1. However, the node 12-2 will reject the MBB PATH from the LER node 12-1 as bandwidth is reserved/occupied by the HP LSP 16. Instead, the LER node 12-2 sends a PATH ERROR message 20-2 to the LER node 12-1. This second PATH ERROR message 30-2 is also not processed. However, despite duplicate PATH ERROR messages, now, the LER node 12-1 will have an MBB failure and have to resend another PATH message, which is exclusive of both interfaces between the nodes 12-2, 12-3.

Thus, as illustrated in FIGS. 2 and 3, in the PATH ERROR message, only that interface address is included on which the LP LSP 14 is first preempted (in this example, the LSR node 12-3). However, it is possible there are also other conflicting interfaces in upstream direction which can result in a second PATH ERROR if the LP LSP 14 is established again using these interfaces as bandwidth might not be available on those interfaces (bandwidth would have been reserved by the HP LSP 16, for example) (in this example, the LSR node 12-2 as well). In FIG. 3, there is an MBB operation on a path which does not have the bandwidth (between the LSR nodes 12-2, 12-3) resulting in an MBB failure. Disadvantageously, the LP LSP 14 could stay in this blocked state until a re-optimization interval or until a PATH TEAR message is sent from a preempting node due to timer expiry. In this case, there can be a larger interval for under provisioning (traffic hit) of the LP LSP 14, as the optimized interval is longer than the timer expiry.

Further, FIGS. 2 and 3 illustrate the inefficiency of the conventional approach, namely each node (LSR node 12-2) in the upstream direction of first conflicting node (LSR node 12-3) (i.e., the first node which generates PATH ERROR message) could generate PATH ERROR message towards the ingress LER node 12-1 in case it also needs to preempt. So, multiple PATH ERROR messages are sent to the ingress LER node 12-1 for the same preempted LP LSP 14. The ingress LER node 12-1 will not process these subsequent PATH ERROR messages as it is already in MBB in-progress state.

### Process to Prevent MBB Failures in MPLS Soft Preemption

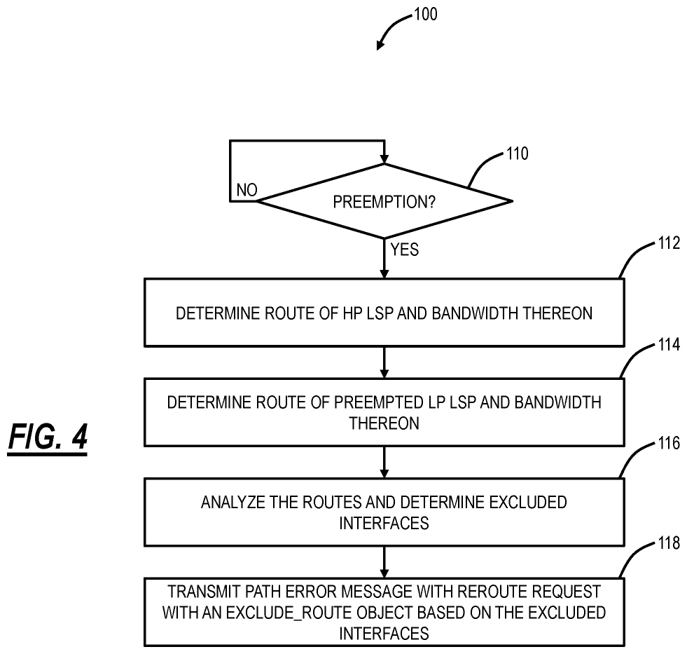

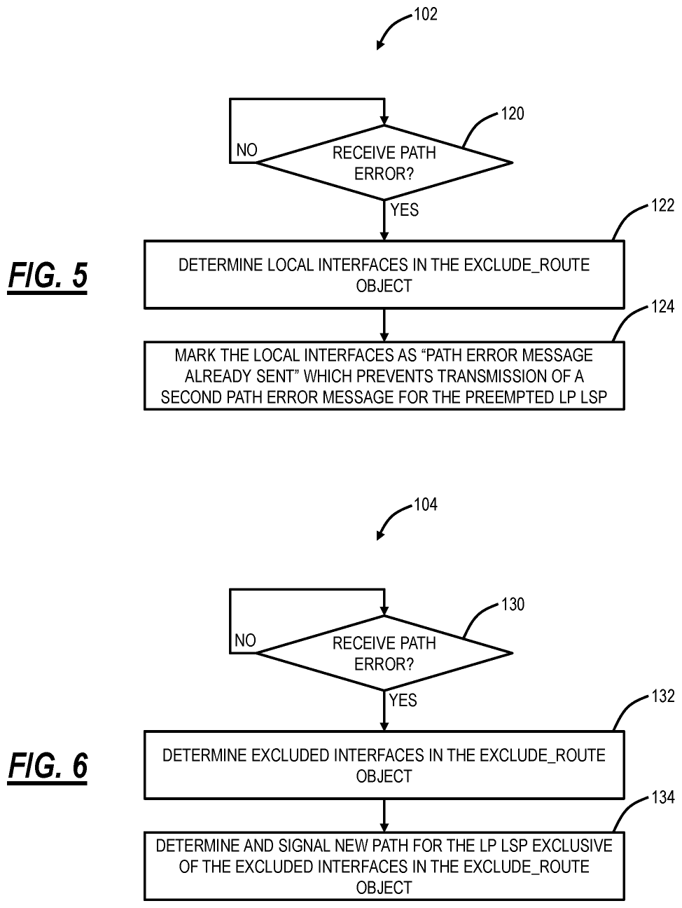

FIG. 4 is a flowchart of a process 100 implemented at an intermediate node, such as the LSR nodes 12-2, 12-3, responsive to a need to preempt a lower priority LSP, to prevent MBB failures in MPLS soft preemption. FIG. 5 is a flowchart of a process 102 implemented at an intermediate node, such as the LSR nodes 12-2, 12-3, responsive to receiving a preemption message, to reduce the number of preemption messages in MPLS soft preemption. FIG. 6 is a flowchart of a process 104 implemented at a Label Edge Router (LER), responsive to receiving a preemption message, to reroute the lower priority LSP reducing MBB failures. In FIGS. 2 and 3, the process 100 is implemented by the LSR node 12-3 when it receives the RESV message related to the HP LSP 16 to preempt the LP LSP 14. The process 102 is implemented by the LSR node 12-2 when it receives the PATH ERROR message from the LSR node 12-3, to avoid sending the second PATH ERROR message. Finally, the process 104 is implemented by the LER node 12-1 when it receives the PATH ERROR message which includes all excluded interfaces along the path of the LSP 16 so that the LER node 12-1 can reroute the LP LSP 14 away from the HP LSP 16 path avoiding all of the excluded interfaces.

In FIG. 4, when an intermediate node determines preemption is required (step 110) to establish a higher priority LSP, the intermediate node will choose an LSP to preempt (e.g., the LP LSP 14 in the example described herein). Preemption can be required due to the TE parameters such as bandwidth being unable to support the new higher priority LSP. The intermediate node can choose the lower priority LSP based on various approaches, including the explicit priority in the TE parameters.

Once the lower priority LSP is chosen, the intermediate node determines the route of the higher priority LSP and the bandwidth thereon (step 112). Information for choosing the LP LSP 14 can be obtained from the RESV (reservation) message for the higher priority LSP which caused the need for preemption. The bandwidth can be based on IGP updates that are maintained in a TE database at the intermediate node. Other approaches may also be utilized.

Also, the intermediate node determines the route of the preempted lower priority LSP and the bandwidth thereon (step 114). Similarly, this information can be obtained from the TE database. The objective of determining the route of the preempted lower priority LSP is to avoid double booking of bandwidth on interfaces.

The intermediate node analyzes the routes of the HP LSP and the LP LSP and determines excluded interfaces (step 116). The intermediate node can determine the bandwidth availability on interfaces in the higher priority LSP path, to determine if there would be additional upstream excluded interfaces besides the local interface at this intermediate node which caused the preemption. The intermediate node can check if the bandwidth is available on these upstream interfaces to retain the lower priority LSP. This approach gives all the interfaces (in the higher priority LSP path) on which bandwidth will not be available for the lower priority LSP to get established by an MBB operation once it is preempted.

Note, this analysis provides insight as to which additional upstream interfaces should be excluded in the reroute of the lower priority LSP. In the example of FIGS. 2 and 3, this analysis would also determine the upstream interface at the LSR node 12-2 is excluded.

With the excluded interfaces determined, the intermediate node transmits a PATH ERROR message with a reroute request and with an EXCLUDE_ROUTE object specifying all the excluded interfaces (step 118). The EXCLUDE_ROUTE object is added with a list of interfaces in PATH ERROR message.

In FIG. 5, an intermediate node receives a PATH ERROR message (step 120) with a reroute request with an EXCLUDE_ROUTE object specifying multiple excluded interfaces. This is responsive to another node in a path of the lower priority LSP determining the need for preemption and performing the process 100. The intermediate node determines (identifies) its local interfaces in the EXCLUDE_ROUTE object (step 122) and makes these local interfaces as “PATH ERROR message already sent” (or some equivalent) which prevents transmission of a second (or more) PATH ERROR message for the preempted lower priority LSP (step 124).

The process 102 is used to avoid sending multiple PATH ERROR messages to the ingress LER for the same preempted LSP. Here, the intermediate node is an upstream node of the lower priority LSP which received the PATH ERROR message from a downstream node. In the example of FIGS. 2 and 3, this upstream intermediate node can be the LSR node 12-2 which receives the PATH ERROR message from the LSR node 12-3 (which performed the process 100). Accordingly, when the LSR node 12-2 receives the RESV message for the HP LSP 16, it can skip sending the PATH ERROR message to the ingress LER node 12-1 because the relevant information is already captured in the EXCLUDE_ROUTE object.

In FIG. 6, the ingress LSR receives the PATH ERROR message with a soft preemption reroute request (step 130) and determines that excluded interfaces are included in the EXCLUDE_ROUTE object (step 132). The ingress LER determines and signals a new path for the lower priority LSP exclusive of the excluded interfaces in the EXCLUDE_ROUTE object (step 134). Advantageously, the ingress LSR can make an informed decision for a new path reducing MBB failures.

In an embodiment, the processes 100, 102, 104 prevent Make Before Break (MBB) failures during soft preemption of a lower priority Label Switched Path (LSP). The process 100 includes, responsive to a determination the lower priority LSP needs preemption, determining a first route of a higher priority LSP which caused the preemption and bandwidth on the first route; determining a second route which is a current route of the lower priority LSP and bandwidth on the second route; analyzing the first route and the second route to determine one or more excluded interfaces which do not support the lower priority LSP due to the higher priority LSP; and transmitting a preemption message designating a soft preemption of the lower priority LSP including all of the excluded interfaces therein along the path of the LP LSP towards an ingress node for the lower priority LSP.

The preemption message can include a PATH ERROR message and the excluded interfaces are listed in an EXCLUDE_ROUTE object. The process 102 can include receiving a second preemption message for a second lower priority LSP and a second higher priority LSP; determining any local interfaces listed in the excluded interfaces of the second preemption message; and preventing transmission of any preemption messages for the second higher priority LSP based on the local interfaces which are included in the excluded interfaces of the second preemption message. The process 104 can include receiving a second preemption message for a second lower priority LSP and a second higher priority LSP, wherein the intermediate node is an ingress node for the second lower priority LSP; determining any excluded interfaces listed in the excluded interfaces of the second preemption message; and determining and signaling a new path for the second lower priority LSP exclusive of the excluded interfaces.

The excluded interfaces can include an address of a local interface at the intermediate node and one or more addresses of remote interfaces at nodes upstream and/or downstream from the intermediate node. The preemption message is transmitted to upstream to an ingress node for the lower priority LSP and through one or more additional intermediate nodes. The one or more additional intermediate nodes can analyze the preemption message for any of its local interfaces contained in the excluded interfaces and prevents sending another preemption for the lower priority LSP for any local interface in the excluded interfaces. The ingress node determines and signals a new path for the lower priority LSP exclusive of the excluded interfaces upon receipt of the preemption message.

### Example Operation

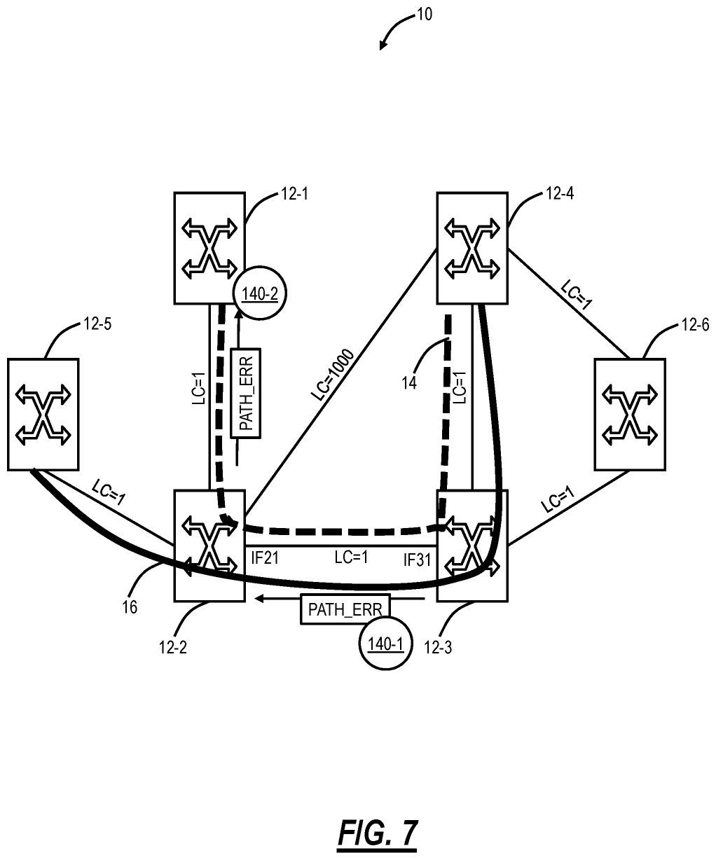

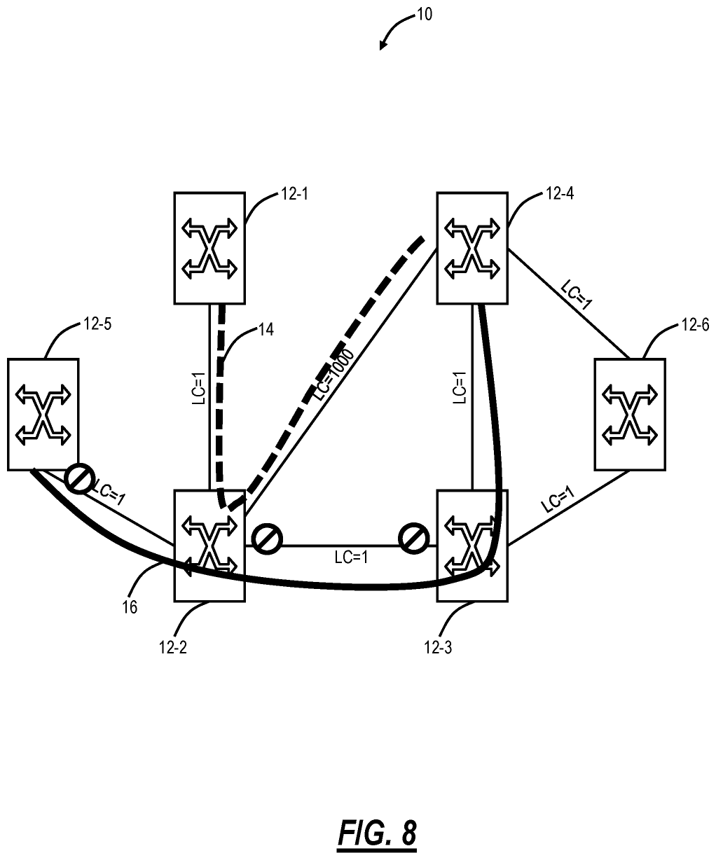

FIGS. 7 and 8 are network diagrams of the MPLS network 10 describing soft preemption of the Low Priority (LP) Label Switched Path (LSP) 14 based on the High Priority (HP) LSP 16, utilizing the process 100, 102, 104. Note, this is similar to the example in FIGS. 2 and 3, but utilizing the process 100, 102, 104 to prevent the MBB failure. In FIG. 7, the LSR node 12-3 receives the RESV message for the HP LSP 16 and performs the process 100 which determines interfaces IF31, IF21 are excluded interfaces for the LP LSP 14 on the path of the HP LSP 16, i.e., the ingress LER node 12-1 should avoid these interfaces in any reroute to avoid MBB failures. Note, the LSR node 12-3 determines the need for preemption based on the local IF31 interface, but also uses the analysis to determine the remote IF21 interface on the LSR node 12-2 is also excluded. The LSR node 12-3 sends a PATH ERROR message destined for the ingress LER node 12-1 with the EXCLUDE_ROUTE object listing the interfaces IF21, IF31 (e.g., their IP addresses) (step 140-1).

The LSR node 12-2 receives the PATH ERROR message and implements the process 102 determining the local interface IF21 is included in the EXCLUDE_ROUTE object. The LSR node 12-2 can suppress its typical local PATH ERROR message which was previously sent in FIGS. 2 and 3.

The ingress LER node 12-1 receives the PATH ERROR message from the LSR node 12-3 with the EXCLUDE_ROUTE object and the ingress LER node 12-1 performs the process 104 where the ingress LER node 12-1 excludes all interfaces (IF21, IF31) in the EXCLUDE_ROUTE object in determining a next best route available for the LP LSP 14.

In FIG. 8, the ingress LER node 12-1 establishes a new path for the LP LSP 14 between the nodes 12-1, 12-2, 12-4. Note, this includes routing over the high-cost link (LC=1000), but that is the only available link in this example based on the excluded interfaces.

In an embodiment, the MPLS network 10 is configured to prevent Make Before Break (MBB) failures during soft preemption of a lower priority Label Switched Path (LSP). Again, the MPLS network 10 includes a plurality of nodes 12 interconnected by a plurality of links; wherein a lower priority LSP 14 is configured over the plurality of links, and, responsive to a reservation for a higher priority LSP 16, an intermediate node 12-3 of the plurality of nodes is configured to determine a requirement to preempt the lower priority LSP 14 due to the higher priority LSP 16, determine a first route of the higher priority LSP 16 and bandwidth on the first route, determine a second route which is a current route of the lower priority LSP 14 and bandwidth on the second route; analyze the first route and the second route to determine one or more excluded interfaces IF21, IF31 which do not support the lower priority LSP 14 due to the higher priority LSP 16; and transmit a preemption message designating a soft preemption of the lower priority LSP 14 including all of the excluded interfaces therein to an ingress node for the lower priority LSP 14.

The preemption message can include a PATH ERROR message and the excluded interfaces are listed in an EXCLUDE_ROUTE object. Another intermediate node 12-2 is configured to, responsive to reception of the preemption message, determine any local interfaces listed in the excluded interfaces of the preemption message, and prevent transmission of any preemption messages for the higher priority LSP based on the local interfaces which are included in the excluded interfaces of the preemption message. An ingress node 12-1 of the lower priority LSP 14 is configured to, responsive to reception of the preemption message, determine any excluded interfaces listed in the excluded interfaces of the preemption message, and determine and cause signaling of a new path for the lower priority LSP 14 exclusive of the excluded interfaces.

### Example Node

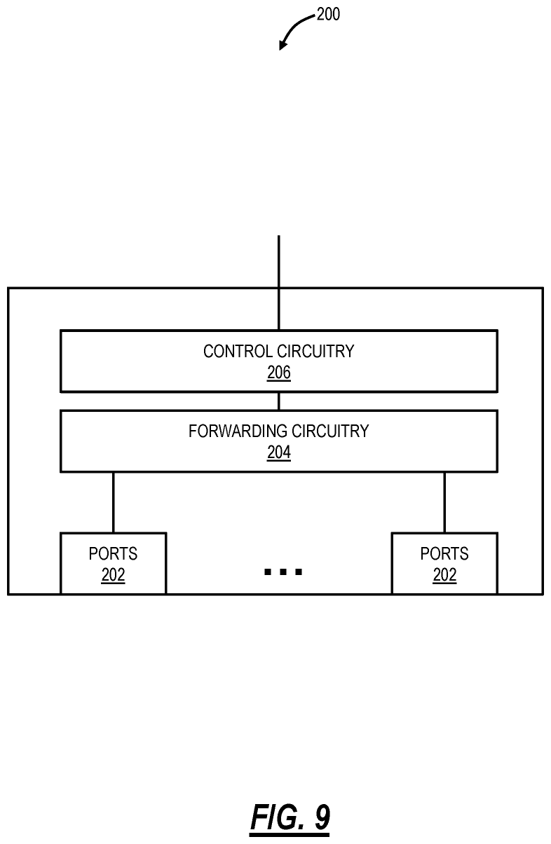

FIG. 9 is a block diagram of an example implementation of a node 200 which may be used with the systems and methods. The node 200 is a switch for illustration purposes, but those of ordinary skill in the art will recognize the systems and methods described herein contemplate other types of network elements and other implementations. In this embodiment, the node 200 includes a plurality of ports 202, forwarding circuitry 204, and control circuitry 206. The node 200 can be an LER, LSR, P (Provider) node, Provider Edge (PE) node, etc. The nodes 12 can utilize this example implementation of the node 200, but other embodiments are also contemplated.

The ports 202 provide physical connectivity of the node 200 to other network elements, switches, routers, etc. The ports 202 are configured to provide ingress and egress of data such as packets, frames, wavelengths, etc. over an LSP and utilizing the systems and methods described herein. For example, the forwarding circuitry 204 is configured to forward packets with MPLS labels. The control circuitry 206 is configured to provide exchange and/or flooding of labels associated with the node 200, IGP updates, etc. and to maintain a TE database based on the flooding. For example, the control circuitry 206 can perform the Intermediate System-Intermediate System (IS-IS) protocol, IS-IS with TE extensions, RSVP-TE, and/or Label Distribution Protocol (LDP) for packets.

The forwarding circuitry 204 and the control circuitry 206 can be configured to implement the processes 100, 102, 104 based on received data (including RESV, PATH ERROR, PATH, etc. messages) on the ports 202.

In an embodiment, the node 200 is in the MPLS network 10 and configured to prevent Make Before Break (MBB) failures during soft preemption of a lower priority Label Switched Path (LSP). Again, the node 200 includes a plurality of ports 202, the forwarding circuitry 204 configured to forward data between the plurality of ports 202; and control circuitry 206 communicatively coupled to the plurality of ports 202 and the forwarding circuitry 204 and configured to, responsive to a determination the lower priority LSP needs preemption, determine a first route of a higher priority LSP which caused the preemption and bandwidth on the first route, determine a second route which is a current route of the lower priority LSP and bandwidth on the second route, analyze the first route and the second route to determine one or more excluded interfaces which do not support the lower priority LSP due to the higher priority LSP, and cause transmission of a preemption message designating a soft preemption of the lower priority LSP including all of the excluded interfaces therein to an ingress node for the lower priority LSP.

The preemption message can include a PATH ERROR message and the excluded interfaces are listed in an EXCLUDE_ROUTE object. The control circuitry 206 can be further configured to, responsive to reception of a second preemption message for a second lower priority LSP and a second higher priority LSP, determine any local interfaces listed in the excluded interfaces of the second preemption message, and prevent transmission of any preemption messages for the second higher priority LSP based on the local interfaces which are included in the excluded interfaces of the second preemption message.

The control circuitry 206 can be further configured to, responsive to reception of a second preemption message for a second lower priority LSP and a second higher priority LSP, wherein the node is an ingress node for the second lower priority LSP, determine any excluded interfaces listed in the excluded interfaces of the second preemption message, and determine and cause signaling of a new path for the second lower priority LSP exclusive of the excluded interfaces.

The excluded interfaces can include an address of a local interface at the node 200 and one or more addresses of remote interfaces at nodes downstream from the node 200. The preemption message can be transmitted upstream to an ingress node for the lower priority LSP and through one or more additional intermediate nodes. The one or more additional intermediate nodes can analyze the preemption message for any of its local interfaces contained in the excluded interfaces and prevent sending another preemption for the lower priority LSP for any local interface in the excluded interfaces. The ingress node can determine and signal a new path for the lower priority LSP exclusive of the excluded interfaces upon receipt of the preemption message.

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A method implemented at an intermediate node in a Multiprotocol Label Switching (MPLS) network to prevent Make Before Break (MBB) failures during soft preemption of a lower priority Label Switched Path (LSP), the method comprising:
responsive to a determination the lower priority LSP needs preemption, determining a first route of a higher priority LSP which caused the preemption and bandwidth on the first route;
determining a second route which is a current route of the lower priority LSP and bandwidth on the second route;
analyzing the first route and the second route to determine one or more excluded interfaces which do not support the lower priority LSP due to the higher priority LSP; and
transmitting a preemption message designating a soft preemption of the lower priority LSP including all of the excluded interfaces therein towards an ingress node along the second route.

2. The method of claim 1, wherein the preemption message comprises a PATH ERROR message and the excluded interfaces are listed in an EXCLUDE_ROUTE object.

3. The method of claim 1, further comprising:
receiving a second preemption message for a second lower priority LSP and a second higher priority LSP;
determining any local interfaces listed in the excluded interfaces of the second preemption message; and
preventing transmission of any preemption messages for the second lower priority LSP based on the local interfaces which are listed in the excluded interfaces of the second preemption message.

4. The method of claim 1, further comprising:
receiving a second preemption message for a second lower priority LSP and a second higher priority LSP, wherein the intermediate node is an ingress node for the second lower priority LSP;
determining any excluded interfaces listed in the excluded interfaces of the second preemption message; and
determining and signaling a new path for the second lower priority LSP exclusive of the excluded interfaces.

5. The method of claim 1, wherein the excluded interfaces comprise an address of a local interface at the intermediate node and one or more addresses of remote interfaces of nodes that are in the first route of the higher priority LSP.

6. The method of claim 1, wherein the preemption message is transmitted to upstream towards an ingress node for the lower priority LSP and through one or more additional intermediate nodes.

7. The method of claim 6, wherein the one or more additional intermediate nodes analyze the preemption message for any of its local interfaces contained in the excluded interfaces and prevents sending another preemption for the lower priority LSP for any local interface in the excluded interfaces.

8. The method of claim 6, wherein the ingress node determines and signals a new path for the lower priority LSP exclusive of the excluded interfaces upon receipt of the preemption message.

9. A node in a Multiprotocol Label Switching (MPLS) network configured to prevent Make Before Break (MBB) failures during soft preemption of a lower priority Label Switched Path (LSP), the node comprising:
a plurality of ports;
forwarding circuitry configured to forward data between the plurality of ports; and
control circuitry communicatively coupled to the plurality of ports and the forwarding circuitry and configured to
responsive to a determination the lower priority LSP needs preemption, determine a first route of a higher priority LSP which caused the preemption and bandwidth on the first route,
determine a second route which is a current route of the lower priority LSP and bandwidth on the second route,
analyze the first route and the second route to determine one or more excluded interfaces which do not support the lower priority LSP due to the higher priority LSP, and
cause transmission of a preemption message designating a soft preemption of the lower priority LSP including all of the excluded interfaces therein towards an ingress node along the second route of the lower priority LSP.

10. The node of claim 9, wherein the preemption message comprises a PATH ERROR message and the excluded interfaces are listed in an EXCLUDE_ROUTE object.

11. The node of claim 9, wherein the control circuitry is further configured to
responsive to reception of a second preemption message for a second lower priority LSP and a second higher priority LSP, determine any local interfaces listed in the excluded interfaces of the second preemption message, and
prevent transmission of any preemption messages for the second lower priority LSP based on the local interfaces which are included in the excluded interfaces of the second preemption message.

12. The node of claim 9, wherein the control circuitry is further configured to
responsive to reception of a second preemption message for a second lower priority LSP and a second higher priority LSP, wherein the node is an ingress node for the second lower priority LSP, determine any excluded interfaces listed in the excluded interfaces of the second preemption message, and
determine and cause signaling of a new path for the second lower priority LSP exclusive of the excluded interfaces.

13. The node of claim 9, wherein the excluded interfaces comprise an address of a local interface at the node and one or more addresses of remote interfaces of nodes that are in a route of the higher priority LSP.

14. The node of claim 9, wherein the preemption message is transmitted to upstream an ingress node for the lower priority LSP and through one or more additional intermediate nodes.

15. The node of claim 14, wherein the one or more additional intermediate nodes analyze the preemption message for any local interface contained in the excluded interfaces and prevent sending another preemption for the lower priority LSP for the local interface in the excluded interfaces.

16. The node of claim 14, wherein the ingress node determines and signals a new path for the lower priority LSP exclusive of the excluded interfaces upon receipt of the preemption message.

17. A Multiprotocol Label Switching (MPLS) network configured to prevent Make Before Break (MBB) failures during soft preemption of a lower priority Label Switched Path (LSP), the MPLS network comprising:
a plurality of nodes interconnected by a plurality of links;
wherein a lower priority LSP is configured over the plurality of links, and, responsive to a reservation for a higher priority LSP, an intermediate node of the plurality of nodes is configured to
determine a requirement to preempt the lower priority LSP due to the higher priority LSP,
determine a first route of the higher priority LSP and bandwidth on the first route,
determine a second route which is a current route of the lower priority LSP and bandwidth on the second route,
analyze the first route and the second route to determine one or more excluded interfaces which do not support the lower priority LSP due to the higher priority LSP, and
transmit a preemption message designating a soft preemption of the lower priority LSP including all of the excluded interfaces therein towards an ingress node along the second route.

18. The MPLS network of claim 17, wherein the preemption message comprises a PATH ERROR message and the excluded interfaces are listed in an EXCLUDE_ROUTE object.

19. The MPLS network of claim 17, wherein another intermediate node is configured to
responsive to reception of the preemption message, determine any local interfaces listed in the excluded interfaces of the preemption message, and
prevent transmission of any preemption messages for the lower priority LSP based on the local interfaces which are included in the excluded interfaces of the second preemption message.

20. The MPLS network of claim 17, wherein an ingress node of the lower priority LSP is configured to
responsive to reception of the preemption message, determine any excluded interfaces listed in the excluded interfaces of the preemption message, and
determine and cause signaling of a new path for the lower priority LSP exclusive of the excluded interfaces.
